(19) United States
(12) Patent Application Publication
(10) Pub. No.: US 2005/0038882 A1
(43) Pub. Date: Feb. 17, 2005

(54) Automated eRoom archive tool and method

(76) Inventors: Anthony A. Huscher, Rocklin, CA (US); Kevin D. Keller, Citrus Heights, CA (US); Troy C. Whitlow, Rosevile, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/640,516

(22) Filed: Aug. 13, 2003

(51) Int. Cl. G06F 15/16; G06F 15/173

(52) U.S. Cl. 709/223; 709/206; 709/224; 709/226

(57) ABSTRACT

In one embodiment of the invention, a method for automated archive of an eRoom, includes: sending a request for rooms for archival; returning a collection of target rooms in response to the request; inserting the target rooms in a database; sending a warning message to an individual associated with the target rooms, the warning message indicating a required access to the target rooms within a timeframe in order to prevent archival of the target rooms; checking if a target room is accessed within the timeframe after sending the warning message; and archiving the target room, if the target room has not been accessed within the timeframe. In another embodiment of the invention, an apparatus is provided for automated archive of an eRoom.

### TECHNICAL FIELD

This disclosure relates generally to server technology, and more particularly to an automated eRoom archive tool and method.

### BACKGROUND

Web collaboration and e-business solutions may be provided by use of an application known as the eRoom server application (“eRoom”) from eROOM TECHNOLOGIES, INCORPORATED <www.eroom.com>. The eRoom server application is disclosed in, for example, U.S. Pat. No. 6,230,285 to Pito Salas et al. and in U.S. Pat. No. 6,233,600 to Pito Salas et al. The eRoom application can run on the MICROSOFT WINDOWS 2000 server family of products from MICROSOFT CORPORATION. One version of eRoom can be deployed using either a built-in database engine which utilizes SQLAnywhere or deployed using the Microsoft SQL 2000 server or SQL Server 7 database. The eRoom application also has a dynamic link library (DLL) called “eRoomAPI.dll” (also referred to as the “eRoom DLL”).

A “room” (or “Room”) is a set of connected HTML (hypertext markup language) pages that are provided a virtual workroom for particular members of a team. The team may vary in size, location, or assignment in a corporate organization. The eRoom pages may display, for example, project-related files, data, and discussion lists. Members of a team may congregate, share work and files, discuss ideas, stay informed, and otherwise collaborate on common projects using a “room”.

Rooms that are no longer being used and are using space in the eRoom server memory are problematic once an eRoom environment becomes heavily utilized. In the current eRoom server technology, the process of discovering which rooms were being used and then contacting the users to see if they still need to use their rooms was a tedious process. For example, an eRoom server administrator (or other designated personnel) is required to manually search for rooms that should be archived, and to manually track which particular rooms could be archived and check the status of the rooms in the archival process. The eRoom server administrator would also need to manually inform an eRoom coordinator about the particular rooms that are candidate with archival, so that the eRoom server administrator can determine if the rooms are still needed by an eRoom coordinator and should not be archived. Once a room has been flagged for archival, then the eRoom server administrator would have to export the room and then copy the file (in .erm format) to the archive server. Then, the temporary .erm file would have to be manually removed from an exports folder (e.g., ServerData\Exports folder). After the above steps, there would still be files left over from the rooms that were exported because the database usually had some bad links from a previous migration. Furthermore, without thorough documentation, rooms could easily be removed at a time that is earlier than proper, and without notification to the users about the archival of the rooms.

Therefore, the current technology is limited in its capabilities and suffers from at least the above constraints and deficiencies.

### SUMMARY OF EMBODIMENTS OF THE INVENTION

In one embodiment of the invention, a method for automated archive of an eRoom, includes:
sending a request for rooms for archival;
returning a collection of target rooms in response to the request;
inserting the target rooms in a database;
sending a warning message to an individual associated with the target rooms, the warning message indicating a required access to the target rooms within a timeframe in order to prevent archival of the target rooms;
checking if a target room is accessed within the timeframe after sending the warning message; and
archiving the target room, if the target room has not been accessed within the timeframe.

In another embodiment of the invention, an apparatus for automated archive of an eRoom, includes:
an automated archive tool configured to send a request for rooms for archival and receive a collection of target rooms in response to the request; the automated archive tool further configured to insert the target rooms in a database, send a warning message to an individual associated with the target rooms, the warning message indicating a required access to the target rooms within a timeframe in order to prevent archival of the target rooms, and to check if a target room is accessed within the timeframe after sending the warning message, and archive the target room, if the target room has not been accessed within the timeframe.

In yet another embodiment of the invention, an apparatus for automated archive of an eRoom, includes:
means for sending a request for rooms for archival;
means for returning a collection of target rooms in response to the request;
means for inserting the target rooms in a database;
means for sending a warning message to an individual associated with the target rooms, the warning message indicating a required access to the target rooms within a timeframe in order to prevent archival of the target rooms;
means for checking if a target room is accessed within the timeframe after sending the warning message; and
means for archiving the target room, if the target room has not been accessed within the timeframe.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a functional block diagram of a system (apparatus) for providing an automated archive process for enhancing the eRoom application, in accordance an embodiment of the invention.

FIG. 2 is a block diagram of a table that can be used by an embodiment of the invention.

FIG. 3 is a block diagram of another table that can be used by an embodiment of the invention.

FIG. 4 is a flowchart that illustrates an overview of a method for an automated archive process, in accordance with an embodiment of the invention.

FIG. 5 is a flowchart that illustrates a method of obtaining a collection of rooms that satisfy the requirements for archival, in accordance with an embodiment of the invention.

FIG. 6 is a flowchart that illustrates a method of adding target rooms to be archived, in accordance with an embodiment of the invention.

FIG. 7 is a flowchart that illustrates a method of canceling the archive process for rooms that have changed (accessed), in accordance with an embodiment of the invention.

FIG. 8 is a flowchart that illustrates a method of sending warning messages, in accordance with an embodiment of the invention.

FIG. 9 is a flowchart that illustrates a method of archiving all rooms that have no members (users), in accordance with an embodiment of the invention.

FIG. 10 is a flowchart that illustrates a method of archiving rooms that have passed the pending timeframe, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

An embodiment of the invention provides a method for an automated eRoom archive process that helps to maintain an eRoom server without any required interaction from the eRoom server administrators. By archiving particular rooms in the eRoom application, disk space can become available for new rooms in the eRoom server.

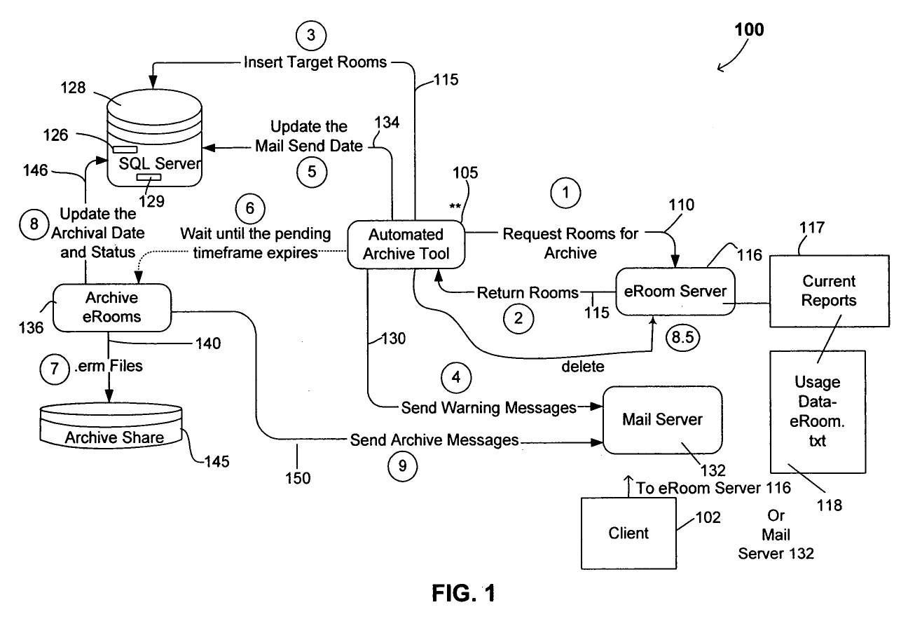

FIG. 1 is a functional block diagram of a system 100 for providing an automated archive tool 105 for archiving the rooms in an eRoom application in an eRoom server 116, in accordance an embodiment of the invention. In one embodiment, the automated archive tool 105 is initiated as a scheduled task (e.g., the method provided by the automated archive tool 105 is initiated at a scheduled time). In step 1, the automated archive tool 105 sends a request 110 to an eRoom server 116 for a collection of rooms that need to be archived. The eRoom server 116 is typically a server that runs the eRoom application. The automated archive tool 105 is typically implemented on the eRoom server 116, as a scheduled application via Windows Task Manager.

In step 1, the automated archive tool 105 sends a request for rooms for archival and checks a “current reports” 117 folder in the eRoom server 116. The automated archive tool 105 checks the UsageData-eRoom.txt file 118 in the current reports folder. The UsageData-eRoom.txt file 118 is a standard text file (or other suitable format) that is generated by the eRoom application and contains standard usage information about a room. By checking the UsageData-eRoom.txt file 118, the automated archive tool 105 can determine when the last day/time that each particular room (in the eRoom server 116) was logged into (accessed) by a user. The automated archive tool 105 then compares this last log-in occurrence for each particular room with a timeframe value. As an example, this timeframe value is 60 days in the discussion herein, although the timeframe value may be set to other number of days (e.g., 30 days or other number of days).

In step 2, all rooms 115 that have a last log-in occurrence that is longer than the timeframe of 60 days (in this example) are returned to the automated archive tool 105, and steps 3 to 9 are then performed. For example, if the last log-in occurrence for a room 115 is 61 days (or longer), then that room 115 will be returned to the automated archive tool 105 in step 2 for processing as discussed below.

In response to one or more rooms 115 that are returned to the automated archive tool 105, the method proceeds to step 3. The automated archive tool 105 inserts the returned rooms 115 (i.e., “target rooms” 115) into a database 126 in a server 128. The server 128 is typically an SQL server.

In step 4, the automated archive tool 105 then sends a warning message 130 to all individuals associated with the target rooms 115. The individuals who are sent the warning message 130 may be a user(s) of the target rooms 115 and/or coordinator(s) of the target rooms 115. A “coordinator” is defined as an administrator of a particular room(s). A coordinator can add users or objects in her/his room, create security features in her/his room, and add/delete particular features in her/his eRoom.

The warning message 130 is typically sent as an electronic mail via a mail server 132. A user/coordinator of a target room 115 can access the mail server 132 by, for example, use of an appropriate client device 102 or by directly accessing the mail server 132 itself. The warning message 130 may, for example, indicate to the user/coordinator that his/her assigned room 115 is a target for archival, since the room 115 has not been logged into (or accessed) within the given timeframe value of 60 days, and that the user/coordinator should log into the target room(s) 115 if he/she wants to prevent the archival of the target room(s) 115. Other suitable warning messages 130 may be sent to alert a user and/or coordinator about a room(s) that is a target for archival.

In step 5, the automated archive tool 105 will send an update 134 to the SQL server 128 to update the database 126, in order to indicate the most recent date that the warning message 130 was sent to user(s)/coordinator(s) of the target rooms 115. For example, since a warning message 130 was previously sent in step 4 to the user(s)/coordinator(s) of the target rooms 115, the update message 134 will update the database 126 to indicate the date that the warning message 130 was sent to the user(s)/coordinators(s) of the target rooms 115.

In step 6, if no user/coordinator logs into a target room 115 within the timeframe period of 60 days (in this example), then the automated archive tool 105 will perform a room archive process 136 for that target room 115. In other words, the target room 115 has met all the requirements for archival. The room archive process 136 is also performed for other target rooms 115 in which no user/coordinator logs into within the timeframe of 60 days (i.e., the room archived process 136 is performed on other target rooms 115 that meet the requirements for archival). Since the automated archive tool 105 is initiated as a scheduled task (e.g., once every evening), the automatic archive tool 105 will check each target room 115 during the scheduled task, in order to determine which particular target rooms 115 have satisfied the requirements for archival.

In step 7, each target room 115 that will be archived is stored as an .erm file 140 into an archive share database 145. The .erm file is typically a zip file.

A target room 115 (that satisfies the requirements for archival) is stored into the archive share database 145, typically by using a standard export function in the eRoom application. The automated archive tool 105 triggers the export function in eroom for a given room marked for archival. The tool 105 then performs the archival of the resulting .erm file for the export process to the archival share database 145.

In step 8, the automated archive tool 105 sends an update 146 to the database 126 to indicate that the particular target rooms 115 that have been archived into the archive share database 145, and to indicate that the status of the particular archived target rooms have changed in status from archival pending to archival complete. Thus, the automated archive tool 105 maintains the status of all target rooms, by updating the database 126.

In subsequent step 8.5, the automated archive tool 105 will delete the particular rooms 115 that have been archived into the archive share database 145. The automated archive tool 105 can determine the particular rooms 115 that have been archived by checking the recently-updated database 126.

It is also noted that the room deletion step of step 8.5 may occur in other sections of the automated archive process of FIG. 1. For example, the room deletion step 8.5 may occur after step 9 when users/coordinators are notified of the particular target rooms 115 that have been archived.

In step 9, the automated archive tool 105 will send an archive message 150, via the mail server 132, to the user(s)/coordinator(s) of the target rooms 115 that have been archived. The archive message 150 will indicate the archival of the particular target rooms 115 that have been stored in the archive share database 145.

Additionally or alternatively, in step 9, the archive message 150 may be a message that indicates that the target room(s) 115 were not successfully archived.

It is also noted that the warning message 130 and/or archive message 150 to the user(s)/coordinator in the method above can be optionally disabled or the text of the message can be set in a manner known to those skilled in the art.

The automated archive tool 105 will remove rooms that are marked from the SQL database list for the archival.

A suitable general DLL API could be used for configuring the automated archive tool 105 to provide access to the settings for the automated eRoom archive method mentioned above and to change these settings, in one embodiment of the invention. The settings may be, for example, the settings for timeframe value (e.g., 30 days or 60 days) as used in step 1 and step 6, the content of the warning message 130 and/or archive message 150, the enabling or disabling or the warning message 130 function and/or the archive message 150 function, and/or any default messages are stored in the database 126. Additional preconfigured database connections are established with the DLL API.

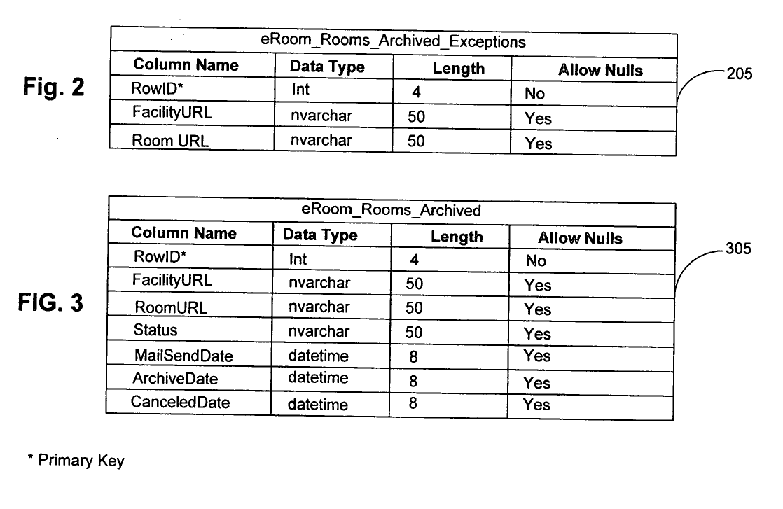

FIG. 2 is a block diagram of a table 205 that can be used by an embodiment of the invention. The table 205 is an archive exceptions table that contains a list of rooms that should not be archive, even if the rooms meet the requirements for archival as discussed above. The table 205 is typically stored in the database 126 in the SQL server 128.

In an embodiment, the table 205 includes the following columns: “Column Name” which identifies particular data information, “Data Type” which identifies the data type for the particular data information in the “Column Name” category, “Length” which indicates the length of a data type, and “Allow Nulls” which permits the automated archive tool 105 to ignore one or more data information in the “Column Name” category, if the Null setting in a corresponding field in the “Allows Null” column is set to “yes” or other suitable flag value. The null category means that no data values are allowed to be entered for that particular column.

The “RowID” field serves as a primary key. As known to those skilled in the art, primary keys identify an indexed field that maintains the primary sequence of a table or file to access the row. The RowId is a unique identifier to identify each of the rooms that are marked for archival and rooms that are exempt from archival.

A “FacilityURL” field indicates a URL (Uniform Resource Locator) address of a facility. A “facility” is defined as a directory of rooms. Each facility is viewed by a user as a directory of eRoom pages.

A “RoomURL” field indicates a URL address of a particular room.

FIG. 3 is a block diagram of another table 305 that can be used by an embodiment of the invention. The table 305 is an archive rooms table that contains a list of rooms 115 that are candidate for archival or rooms that have been previously archived. The table 305 is typically stored in the database 126 in the SQL server 128.

In an embodiment, the table 305 includes the columns, “Column Name”, “Data Type”, “Length”, and “Allow Nulls”, as similarly described with references to table 205 of FIG. 2.

A “Status” data field indicates if a particular room has been archived or is not archived.

A “MailSendDate” field indicates when the automated archive tool 105 had previously sent a warning message 130 to the user(s)/coordinator of the particular target room 115. The “MailSendDate” field is updated by the automated archive tool 105 by sending the update 134 in step 5 of FIG. 1.

The “ArchiveDate” field indicates when the particular target room 115 was archived. The “ArchiveDate” field is updated by the automated archive tool 105 by sending the update 146 in step 8.

The “CanceledDate” field indicates when the particular room was canceled for archival. The “CanceledDate” field is also updated by the automated archive tool 105.

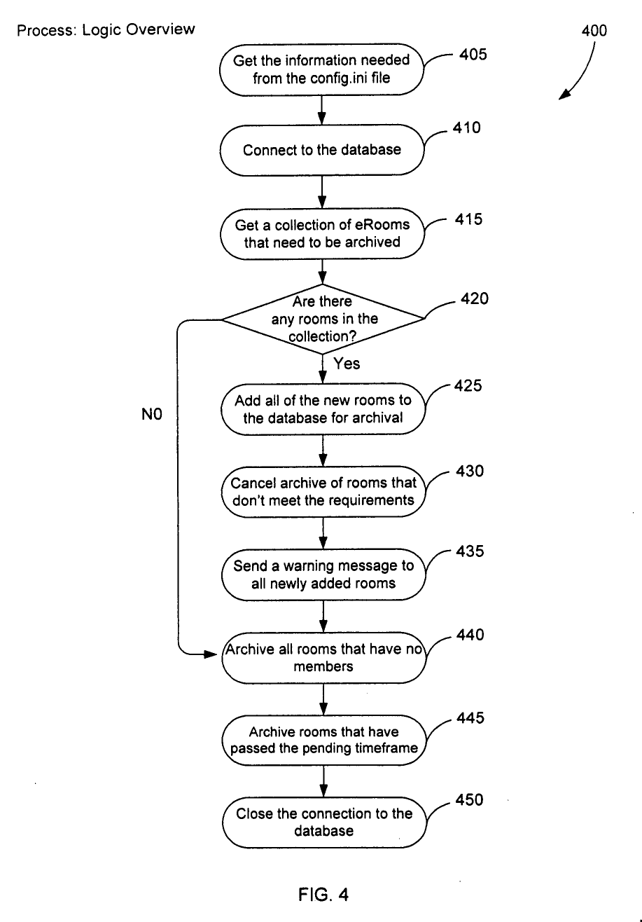

FIG. 4 is a flowchart that illustrates an overview of a method 400 for an automated archive process, in accordance with an embodiment of the invention. A suitable DLL API is used to establish connection with various databases. The DLL API is used to obtain (405) information from a configuration file (config.ini) 129 (see FIG. 1) in the SQL server 128. The config.ini file 129 will contain properties of the eRoom application in the eRoom server 116, properties of other applications in the system 100, and the destination database in which a room will be stored for archival.

The automated archive tool 105 then connects (410) to a database in the eRoom server 116. The database name and other information are obtained from the config.ini file 129 in the SQL server 128.

A collection of rooms (i.e., eRooms) is then obtained (415) from the database in the eRoom server 116. The collection of rooms will be checked to determine which particular rooms satisfy the requirements for archival.

In step (420) a check is performed to determine if there are any rooms in the collection that needs to be archived. If there are no rooms in the collection, then the method 400 proceeds to step (440), where all rooms with no members (users) are archived. On the other hand, if there is one or more rooms in the collection, then the method 400 proceeds to step (425), where all new rooms (target rooms 115) are added to the database 126 for possible archival.

All rooms that do not meet the requirements for archival are canceled (430). A warning message 130 is then sent to users and/or a coordinator of the rooms that are newly added to the database 125 in step (425). All rooms (in the newly added rooms of step (425)) that have no members are archived (440). A room, in the newly added rooms of step (425), is also archived (445) if no user or coordinator has logged into that room.

The automated archive tool 105 then closes (disconnects)
(450) the connection to the database in the eRoom server 116. As mentioned above, prior to disconnecting the connection to the database, the automated archive tool 105 may delete (in the eRoom server 116) each room that has been archived.

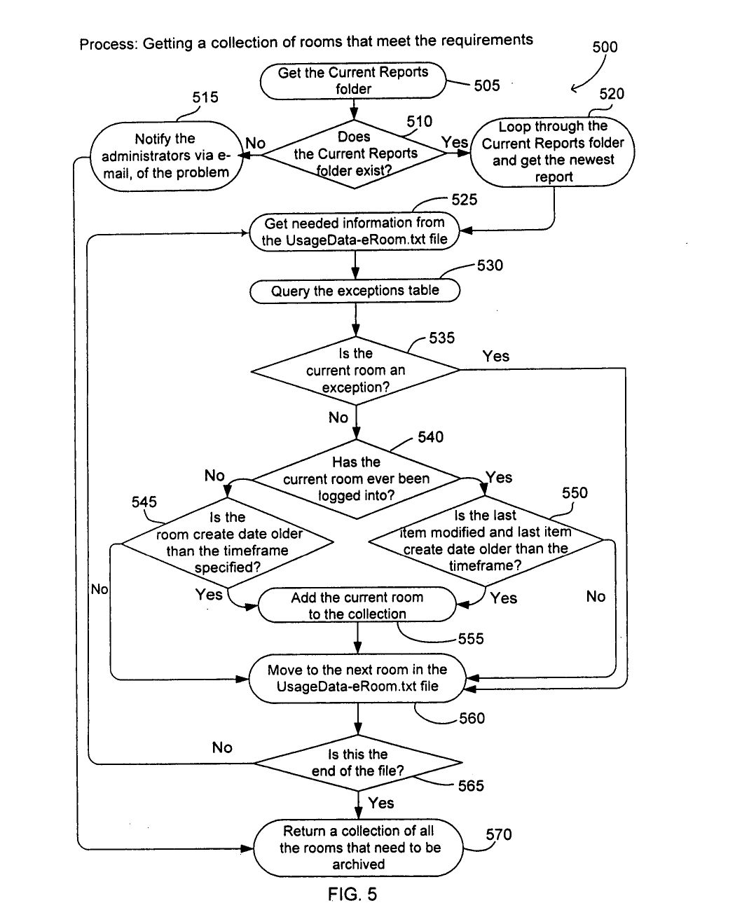

FIG. 5 is a flowchart that illustrates a method 500 of obtaining a collection of rooms 115 that satisfy the requirements for archival, in accordance with an embodiment of the invention. The automated archive tool 105 obtains or accesses (505) the current reports folder in the eRoom server 116.

In step (510), a check is made by the automated archive tool 105 to determine if the current reports folder exists in the eRoom server 116. If the current reports folder does not exist, then the automated archive tool 105 notifies (515) one or more eRoom server administrators about the problem. Typically, this notification is by an e-mail message to the eRoom server administrator. On the other hand, if the current reports folder exists, then the automated archive tool 105 will loop (520) through the current reports folder and obtain the newest (latest) reports in the current reports folder. The automated archive tool 105 will obtain (525) needed information (specifically, the last log in date for a current room) from a UsageData-eRoom.txt file 118.

The automated archive tool 105 will query (530) the exceptions table 205 (FIG. 2) to determine if the current room has an exception in the archival process. If, in step (535), the current room has an exception in the archival process, then the method 500 proceeds to step (560), where the automated archive tool 105 will check the next room in the UsageData-eRoom.txt file 118, and the current room is not archived. On the other hand, if, in step (535), the current room does not have an exception in the archival process, then the automated archive tool 105 checks (540) if the current room has ever been logged into.

If the current room has not been logged into, then a check (545) is made if the room create date of the current room is older than the specified timeframe (e.g., 60 days in the example of FIG. 1). If the room create date of the current room is not older than the specified timeframe, then the method proceeds to step (560), where a next room is checked by the automated archive tool 105. If the room create date of the current room is older than the specified timeframe, then the current room is added (555) to the collection of target rooms 115.

If, in step (550) the current room has been logged into, then a check (550) is made if the last item modified (of a room) or last item create date (of a room) is older than the timeframe (e.g., 60 days in the example of FIG. 1). If the last item modified (of a room) or last item create date (of a room) is not older than the timeframe, then the method proceeds to step (560), where a next room is checked by the automated archive tool 105. If the last item modified (of a room) or last item create date (of a room) is older than the timeframe, then the current room is added (555) to the collection of target rooms 115.

A check (565) is performed to determine if the end of the UsageData-eRoom.txt file 118 has been reached. If the end of the UsageData-eRoom.txt file 118 has not been reached, then the method 500 returns to step (525), where information from the next room is obtained from the UsageData-eRoom.txt file 118. If the end of the UsageData-eRoom.txt file 118 has been reached, then a collection of all the rooms that may be required for archival are returned (570).

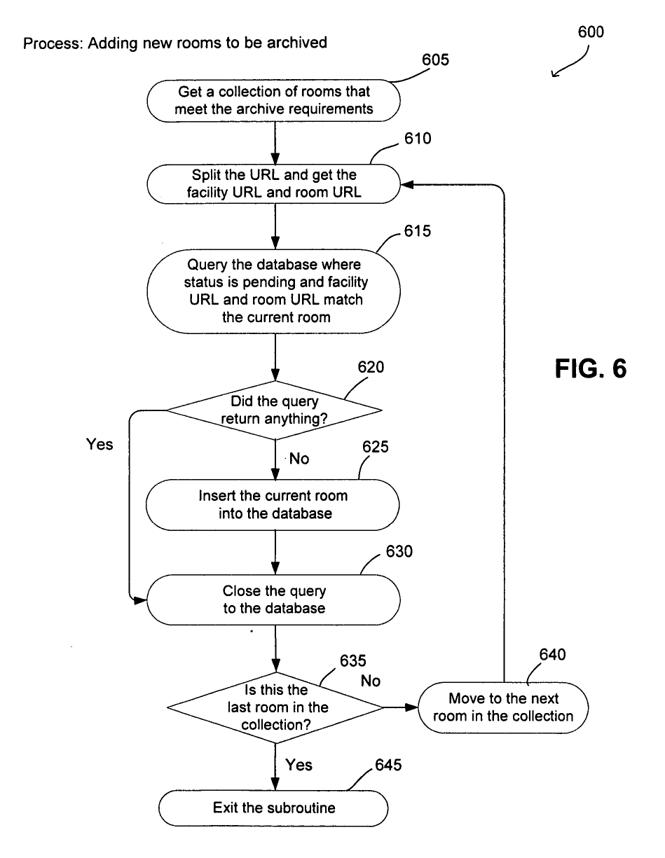

FIG. 6 is a flowchart that illustrates a method 600 of adding target rooms 115 to be archived, in accordance with an embodiment of the invention. The target rooms 115 are added to the SQL server 128. A collection of rooms 115 that meet the archive requirements are obtained (605). For each target room 115 in the collection, the URL of the room is split (610), so that a facility URL and room URL is obtained.

The database 126 (in the SQL server 128) is then queried (615) by the automated archive tool 615. The query is made for target rooms 115 with status that are pending (i.e., target rooms 115 that are not yet archived) and for a facility URL and room URL that match the facility URL and room URL of the current room. A check (620) is made to determine if the query to the database 126 returned any results. If the query returned a result (i.e., at least one room is returned), then the method 600 proceeds to step (630), where the query to the database is closed. On the other hand, if the query did not return a result, then the current room is inserted (625) into the database 126. The query to the database 126 is then closed.

A check (635) is made if the current room is the last room in the collection. If the current room is not the last room in the collection, then the next room in the collection is selected (640) and the method 600 proceeds back to step 610. If the current room is the last room in the collection, then an exit (645) is made from the subroutine and the method 600 ends.

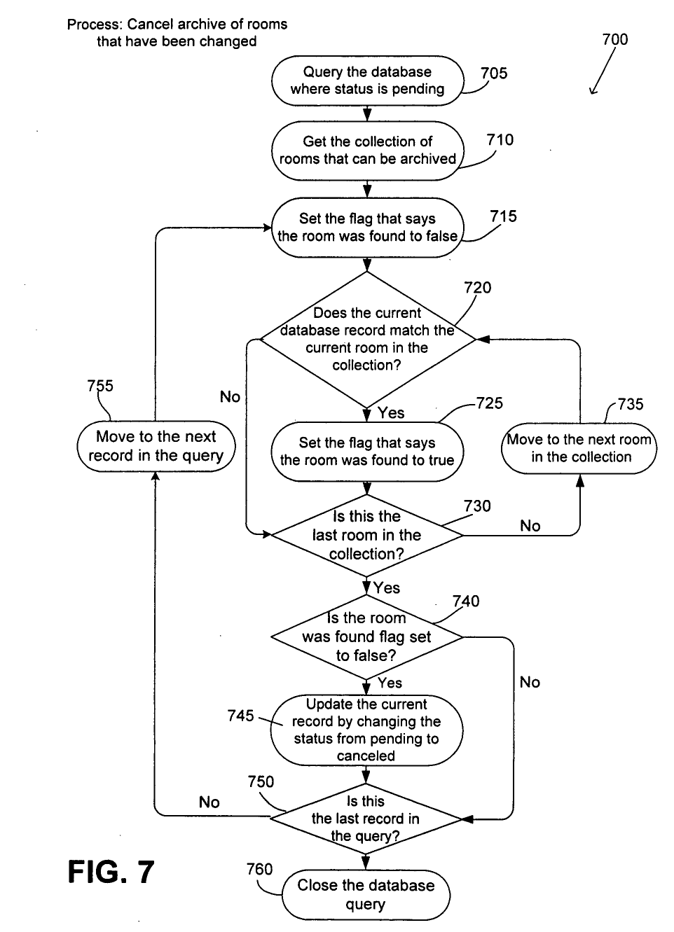

FIG. 7 is a flowchart that illustrates a method 700 of canceling the archive process for rooms that have been changed (accessed), in accordance with an embodiment of the invention. The database 126 is queried (705) for target rooms 115 where the status is pending (i.e., target rooms 115 that are not yet archived). The collection of rooms that can be archived are obtained (710) in response to the query in step (705).

A flag is then set (715), where the flag indicates that the room was found to be false. The flag is used to determine if the room has been deleted outside the auto archive process.

A check (720) is made to determine if the current database record matches the current room in the collection. If the current database record does not match the current room in the collection, then the method 700 proceeds to step (730), where a determination is made if the current room is the last room in the collection. If the current database record matches the current room in the collection, then the flag is set to indicate that the room was found to be true.

In step (730), the determination is made if the current room is the last room in the collection. If not, the next room in the collection is selected (735). If the current room is the last room in the collection, then a determination (740) is made if the flag is set to false for the room. If the flag is not set to false, then the method 700 proceeds to step (750), where a determination is made if the current record is the last record in the query. If the flag was set to false in step (740), then an update (745) is made on the current record by changing the status of the room from archive pending to archive canceled.

In step (750), if the current record is not the last record in the query, then the next record in the query is selected (755) and the method proceeds to step (715). Each record in the query is the information obtained from the rooms archive table 305 (FIG. 3).

In step (750), if the current record is the last record in the query, then the database query is closed (760) and the method 700 ends.

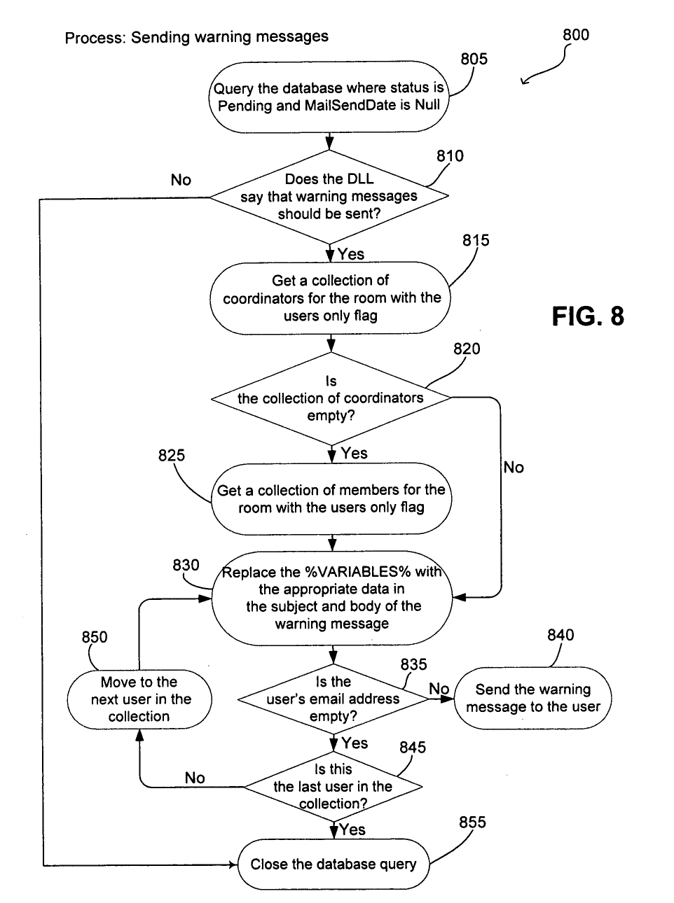

FIG. 8 is a flowchart that illustrates a method 800 of sending warning messages 130, in accordance with an embodiment of the invention. In step (805), the database 126 is queried for target rooms 115 that have pending status (i.e., target rooms 115 that are not yet archived) and where the MailSendDate is null (i.e., the warning message 130 has not yet been sent for these rooms).

A check (810) is made to determine if the DLL API indicates if warning messages 130 should be sent. If the DLL API indicates that warning messages 130 should not be sent, then the method 800 proceeds to step (855), where the database query is closed and the method 800 ends. On the other hand, if the DLL API indicates that warning messages 130 should be sent, then a collection of coordinators for the current room is obtained (815). In step (815), depending on what the flag is set to, the collection returned will either be a list of all the coordinators or coordinators and users combined for notification.

In step (820), if the collection of coordinators is not empty, then the method 800 proceeds to step (830), where a variable % VARIABLES % is replaced with the appropriate data in the subject and body of the warning message 130. In step (820), if the collection of coordinators is empty, then a collection of members for the room is obtained (825), and the method 800 proceeds to step (830).

A check (835) is made for email addresses of users who are designated to receive the warning message 130. The warning message is sent (840) to one of the users. A check (845) is also made to determine if the user is the last user in the collection. If the user is not the last user in the collection, then the next user in the collection is selected (850) and the method 800 proceeds to step (850). If the user is the last user in the collection, then the database query is closed (855) and the method 800 ends.

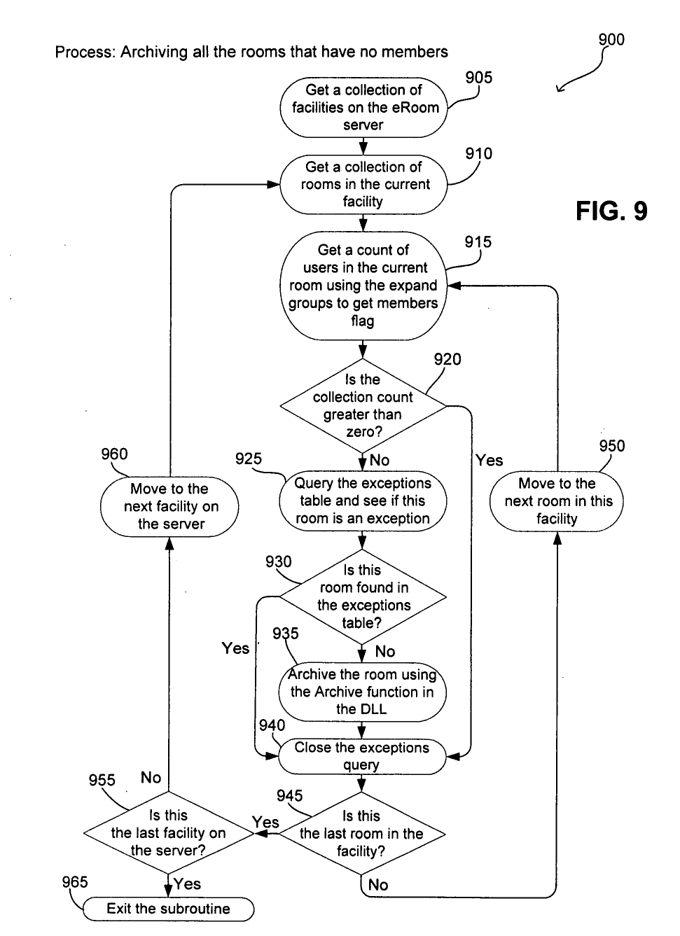

FIG. 9 is a flowchart that illustrates a method 900 of archiving all rooms 115 that have no members (users), in accordance with an embodiment of the invention. A collection of facilities is obtained (905) on the eRoom server 116. A collection of rooms in the current facility is obtained (910). A count of users of a current room is then obtained (915). As an example, the count of users is obtained by using the expanded group to get a members flag. The expanded group is a conventional eRoom feature.

A check (920) is made if the count of users in the current room is greater than zero. If the count of users in the current room is greater than zero, then the method 900 proceeds to step (945), where a check is made if the current room is the last room in the facility. If the count of users in the current room is not greater than zero, then a query is made (925) to the exceptions table 205 (FIG. 2) to determine if the current room is an exception for the archival process.

In step (930), a determination is made if the current room is listed in the exceptions table 205. If the current room is listed in the exceptions table 205, then the method 900 proceeds to step (940), where the query to the exceptions table 205 is closed. If the current room is not listed in the exceptions table 205, then the current room is archived (935). The current room can be archived by, for example, using an archive function in the DLL API.

In step (945), a check is made if the current room is the last room in the facility. If the current room is not the last room in the facility, then the next room in the facility is selected (950), and the method 900 proceeds to step (915). If the current room is the last room in the facility, then a check (955) is made if the facility is the last facility on the eRoom server 116.

If the facility is not the last facility on the eRoom server 116, then the next facility on the eRoom server 116 is selected (960) and the method 900 proceeds to step (910). On the other hand, if the facility is the last facility on the eRoom server 116, then an exit of the subroutine is performed (965) and the method 900 ends.

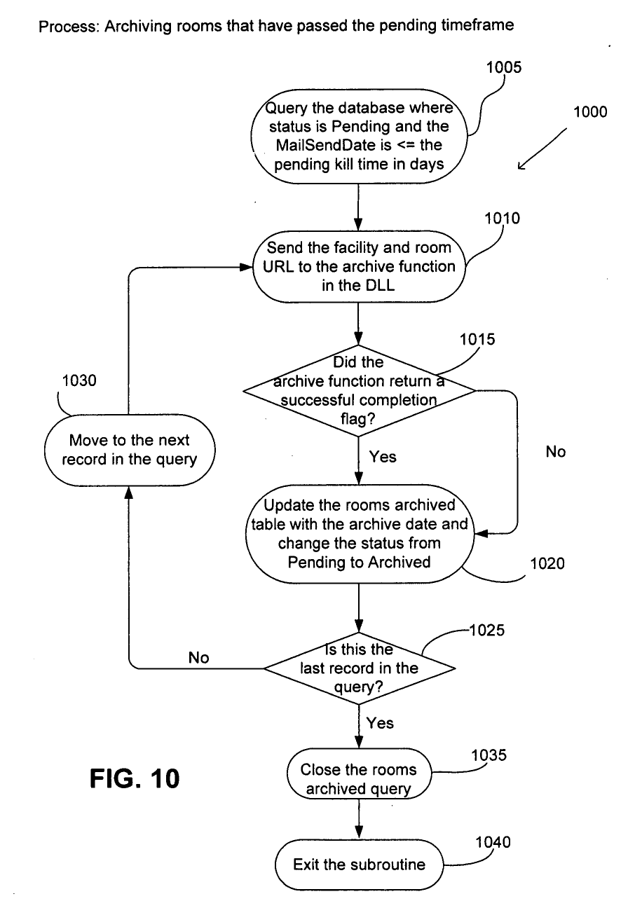

FIG. 10 is a flowchart that illustrates a method 1000 of archiving rooms that have passed the pending timeframe, in accordance with an embodiment of the invention. A query (1005) is made to the database 126 (in SQL server 128) for target rooms 115 with status that are pending (i.e., target rooms 115 that are not yet archived) and where the MailSendDate (the number of days passed when the warning message 130 was sent) is less than or equal to the preset timeframe value (the pending kill time value in days). In the above examples, the timeframe value is set to 60 days. If the MailSendDate is greater then the pending timeframe value (e.g., 60 days), then the facility URL and room URL of the current room is sent (1010) to the archive function in the DLL API, to permit archival of the current room.

In step (1015), a check is made if the archive function has returned a successful completion flag, which indicates that the current room has been successfully archived. If a successful completion flag was not returned or if a successful completion flag was returned, then an update (1020) is performed on the rooms archive table 305 (FIG. 3), to indicate the archive date of the current room and to change the status of the current room from pending to archived, if appropriate. In another embodiment, if a successful completion flag was not returned, then a notification message is sent to a coordinator and/or to users, where the notification message indicates that the current room was not successfully archived.

In step (1025) a check is made if the current record that is being checked in the rooms archive table 305 (FIG. 3) is the last record in the query. If the current record is not the last record in the query, then the next record in the query is selected (1030), and the method 1000 proceeds to step (1010). If the current record is the last record in the query, then the rooms archive query is closed (1035) and an exit of the subroutine is performed (1040), and the method 1000 ends.

The various engines or tools discussed herein may be, for example, software, firmware, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for automated archive of an eRoom, the method comprising:
sending a request for rooms for archival;
returning a collection of target rooms in response to the request;
inserting the target rooms in a database;
sending a warning message to an individual associated with the target rooms, the warning message indicating a required access to the target rooms within a timeframe in order to prevent archival of the target rooms;
checking if a target room is accessed within the timeframe after sending the warning message; and
archiving the target room, if the target room has not been accessed within the timeframe.

2. The method of claim 1, further comprising:
deleting the target room from an eRoom server.

3. The method of claim 1, further comprising:
sending an archive message to the individual associated with the target room, the archive message indicating that the target room has been successfully archived.

4. The method of claim 1, wherein the action of archiving the target room comprises:
storing the target room in an archive share database.

5. The method of claim 1, further comprising:
updating a database to indicate a date of previously sent warning message.

6. The method of claim 1, further comprising:
updating a database to indicate a date of archival of the target room and to change the status of the target room from archival pending to archival complete.

7. The method of claim 1, further comprising:
canceling the archival of a target room that is listed in an archive exception table in the database.

8. The method of claim 1, wherein the warning message comprises an electronic mail message.

9. The method of claim 1, wherein the archive message comprises an electronic mail message.

10. The method of claim 1, wherein the individual is a user of the target room.

11. The method of claim 1, wherein the individual is a coordinator of the target room.

12. The method of claim 1, wherein the database is stored in an SQL server.

13. An apparatus for automated archive of an eRoom, the apparatus comprising:
means for sending a request for rooms for archival;
means for returning a collection of target rooms in response to the request;
means for inserting the target rooms in a database;
means for sending a warning message to an individual associated with the target rooms, the warning message indicating a required access to the target rooms within a timeframe in order to prevent archival of the target rooms;
means for checking if a target room is accessed within the timeframe after sending the warning message; and
means for archiving the target room, if the target room has not been accessed within the timeframe.

14. An article of manufacture, comprising:
a machine-readable medium having stored thereon instructions to:
send a request for rooms for archival and receive a collection of target rooms in response to the request;
insert the target rooms in a database;
send a warning message to an individual associated with the target rooms, the warning message indicating a required access to the target rooms within a timeframe in order to prevent archival of the target rooms;
check if a target room is accessed within the timeframe after sending the warning message; and
archive the target room, if the target room has not been accessed within the timeframe.

15. An apparatus for automated archive of eRooms, the apparatus comprising:
an automated archive tool configured to send a request for rooms for archival and receive a collection of target rooms in response to the request;
the automated archive tool further configured to insert the target rooms in a database, send a warning message to an individual associated with the target rooms, the warning message indicating a required access to the target rooms within a timeframe in order to prevent archival of the target rooms, and to check if a target room is accessed within the timeframe after sending the warning message, and archive the target room, if the target room has not been accessed within the timeframe.

16. The apparatus of claim 15, wherein the automated archive tool is configured to delete the target room from an eRoom server.

17. The apparatus of claim 15, wherein the automated archive tool is configured to send an archive message to the individual associated with the target room, the archive message indicating that the target room has been successfully archived.

18. The apparatus of claim 15, wherein the automated archive tool is configured to archive the target room by storing the target room in an archive share database.

19. The apparatus of claim 15, wherein the automated archive tool is configured to update a database to indicate a date of previously sent warning message.

20. The apparatus of claim 15, wherein the automated archive tool is configured to update a database to indicate a date of archival of the target room and to change the status of the target room from archival pending to archival complete.

21. The apparatus of claim 15, wherein the automated archive tool is configured to cancel the archival of a target room that is listed in an archive exception table in the database.

22. The apparatus of claim 15, wherein the warning message comprises an electronic mail message.

23. The apparatus of claim 15, wherein the archive message comprises an electronic mail message.

24. The apparatus of claim 15, wherein the individual is a user of the target room.

25. The apparatus of claim 15, wherein the individual is a coordinator of the target room.

26. The apparatus of claim 15, wherein the database is stored in an SQL server.
